(19) United States
(12) Patent Application Publication
(10) Pub. No.: US 2015/0143942 A1
(43) Pub. Date: May 28, 2015

(54) POLYMER-BASED BRAIDED CABLE WITH POLYMER-BASED END FITTINGS USED IN AUTOMOTIVE CABLE ASSEMBLIES

(71) Applicant: Magna Closures Inc., Newmarket (CA)

(72) Inventors: Sarah A. Lalonde, Aurora (CA); Frank Stoof, Keswick (CA)

(21) Appl. No.: 14/555,853

(22) Filed: Nov. 28, 2014

Related U.S. Application Data
(60) Provisional application No. 61/910,085, filed on Nov. 28, 2013.

(51) Int. Cl. F16C 1/10; B29C 70/06; E05F 15/00; B29C 45/16; B60J 5/00; F16C 1/20; B29C 45/14

(52) U.S. Cl. CPC F16C 1/10; F16C 1/20; B29C 70/06; B29C 45/14065; B29C 45/14573; B29C 45/14786; B29C 45/1671; B60J 5/00; E05F 15/00
USPC 74/501.6; 74/502.5; 74/502.4; 264/257

(57) ABSTRACT

An automotive cable assembly for mechanically linking a first mechanical system to a second mechanical system for facilitating a transfer of tension loadings there-between, the cable assembly having a multi-stranded polymer-based core element having a first polymer based end fitting at a first end and a second polymer based end fitting at a second end such that the first polymer based end fitting is for retaining a coupling to the first mechanical component of the first end and the second polymer based end fitting is for retaining coupling to the second mechanical component at the second end during the transfer of tension loading. The first mechanical system can be a door latch, the first mechanical component a latch lever, the second mechanical system a door handle/remote and the second mechanical component a door lever. The first mechanical system can be a window motor, the first mechanical component a motor lever, the second mechanical system a window regulator lifter assembly and the second mechanical component a window lifter plate. Also provided are different manufacturing techniques for forming the end fittings.

### FIELD

The present invention is related to cables used in automotive systems.

### BACKGROUND

Current practice in latching systems for release cable applications is to use a standard metal braid tension cable as a mechanical linkage between the latch and a remote location. When a door is unlocked and the door handle/remote is pulled, the metal release cable transmits that action to a release lever in the latch, which in-turn opens the door. As such, current practice for the automotive cable is to use braided steel wire, required to meet the tensile load, environmental and fatigue requirements associated with door latching systems. Presently, the cable end fittings can be manufactured using either metal or composite materials that are mechanically affixed (e.g. crimped) to the cable.

Although steel wire is the current art for automotive cables, the use of steel as a cable material in automotive cable applications can have some inherent design limitations. First, to meet strength requirements the wire cable must have a minimum diameter which dictates the mass of the cable. To comply with government regulations requiring resistance to the effects of inertia in the event of a crash, the mass of the cable must be taken into consideration when designing an automotive mechanical component (e.g. latch). Depending on the influence of the cable mass, the latch can be required to contain additional content in the form of counter-balances and/or springs to offset the mass effect, thus typically employing design iterations to achieve this requirement. Another disadvantage is that the steel cable can be damaged (e.g. kinked) during handling which can also reduce cable efficiency and ultimately increase release efforts and/or reduce travel between cable-coupled automotive components. Another disadvantage is that steel cable can be damaged due to corrosion, as cables can be positioned in body interiors where environmental moisture can be encountered.

Further, when considering the cable routing between automotive components, e.g. from a latch to a remote in a door cavity, by nature steel cable is relatively rigid and as a result there is a required minimum bend radius dependent on the diameter and number of strands in the braided cable construction. Also, there is a relationship between the bend radius and the overall cable efficiency due to frictional forces between the steel wire and conduit housing, which can directly influence the effort to release, an important customer controlled measurement in the automotive industry. Further, cable routing and bend radius are of concern when given limited space or if there are obstacles between the automotive components coupled by the cable.

### SUMMARY

It is an object of the present invention to provide a cable system to obviate or mitigate at least some of the above-presented disadvantages.

A first aspect provided is an automotive assembly comprising: a first mechanical system having a first mechanical component, the first mechanical system configured for mounting on a vehicle; a second mechanical system having a second mechanical component, the second mechanical system configured for mounting on the vehicle, the second mechanical component spaced apart from the first mechanical component; and a cable assembly for mechanically linking the first mechanical system to the second mechanical system for facilitating a transfer of tension loadings therebetween, the cable assembly having a multi-stranded polymer-based core element having a first polymer based end fitting at a first end and a second polymer based end fitting at a second end such that the first polymer based end fitting is for retaining coupling to the first mechanical component of the first end and the second polymer based end fitting is for retaining coupling to the second mechanical component at the second end during the transfer of tension loading.

A second aspect provided is an automotive cable assembly for mechanically linking a first mechanical system to a second mechanical system for facilitating a transfer of tension loadings there-between, the cable assembly having a multi-stranded polymer-based core element having a first polymer based end fitting at a first end and a second polymer based end fitting at a second end such that the first polymer based end fitting is for retaining coupling to the first mechanical component of the first end and the second polymer based end fitting is for retaining coupling to the second mechanical component at the second end during the transfer of tension loading.

A third aspect provided is a method of manufacturing a polymer based end fitting on a multi-stranded polymer-based core element, the method comprising the steps of: positioning an end of the multi-stranded polymer-based core element in a cavity of a mold; applying end polymer material of the polymer based end fitting in the cavity at a prescribed temperature different from a melt temperature of core polymer material of the multi-stranded polymer-based core element, such that a chemical reaction bond is formed between the end polymer material and the core polymer material; allowing the end polymer material to harden to form the polymer based end fitting on the end; and removal of the multi-stranded polymer-based core element with the polymer based end fitting from the mold.

A fourth aspect provided is a method of manufacturing a polymer based end fitting on a multi-stranded polymer-based core element, the method comprising the steps of: positioning an end of the multi-stranded polymer-based core element in end polymer material of the polymer based end fitting; applying a process condition to cause the end polymer material to form around core polymer material of the multi-stranded polymer-based core element, such that a chemical reaction bond is formed between the end polymer material and the core polymer material; and allowing the end polymer material to harden to form the polymer based end fitting on the end.

A fifth aspect provided is a method of manufacturing a polymer based end fitting on a multi-stranded polymer-based core element, the method comprising the steps of: positioning an end of the multi-stranded polymer-based core element including end polymer material of the polymer based end fitting, such that the end polymer material and the core polymer material are integrally connected; processing the end polymer material of the polymer based end fitting to form a reaction bond between the end polymer material and the core polymer material on the end; and allowing the end polymer material to harden to form the polymer based end fitting.

### LIST OF FIGURES

Reference may now be had to the following detailed description, taken together with the accompanying example drawings, by way of example only, in which:

FIG. 1 is a cross sectional view of an automotive system with cable assembly;

FIG. 2 is a side view of the cable assembly of FIG. 1;

FIG. 3a is a side view of a core element of the automotive system of FIG. 1;

FIG. 3b is an alternative side view of a core element of the automotive system of FIG. 1;

FIG. 4 is a side view of a core end fitting of the automotive system of FIG. 1;

FIG. 5a is a block diagram of an example manufacturing process for the core element with end fitting of the automotive system of FIG. 1;

FIG. 5b is a block diagram of an alternative manufacturing process for the core element with end fitting of the automotive system of FIG. 1;

FIG. 6 shows experimental testing conditions for a number of different configurations of the cable assembly of FIG. 1;

FIG. 7 shows a further embodiment of the automotive system with cable assembly of FIG. 1; and

FIG. 8 shows a still further embodiment of the automotive system with cable assembly of FIG. 1.

### DESCRIPTION

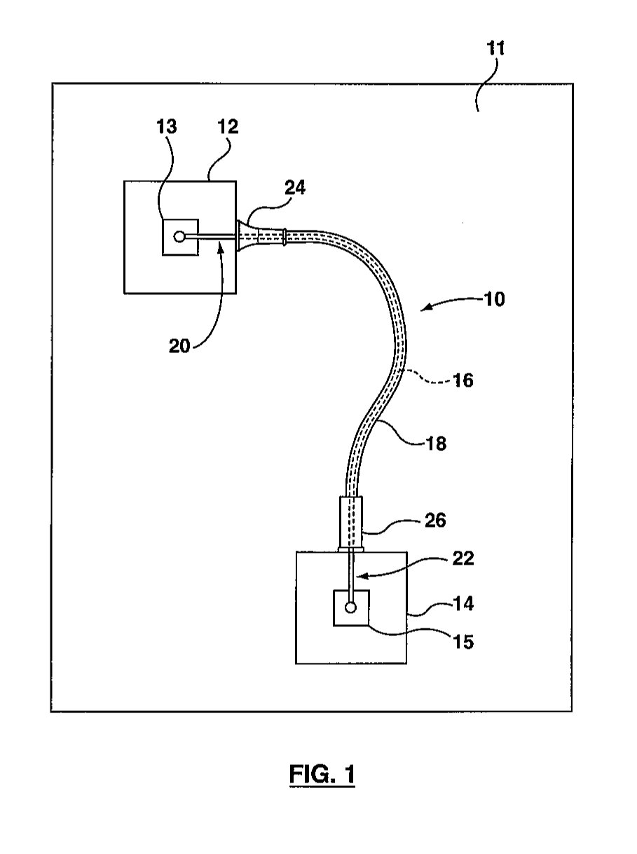

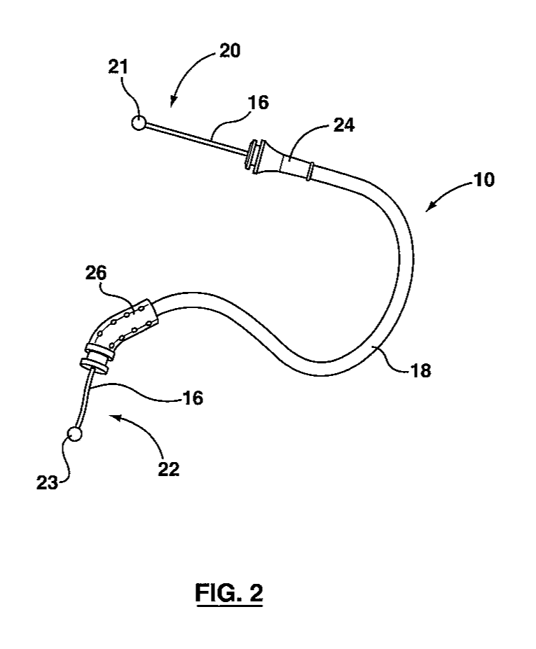

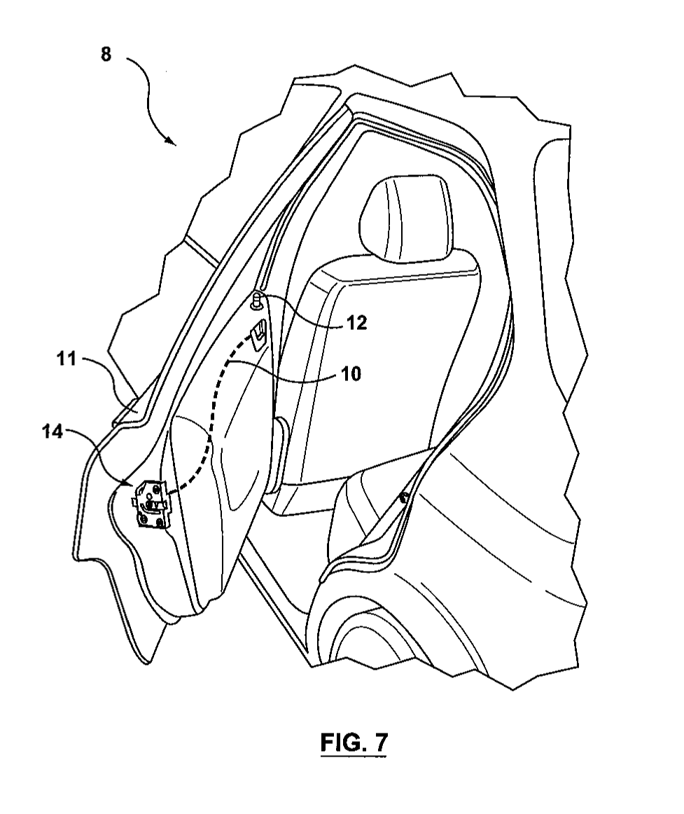

Referring to FIGS. 1 and 2, shown is a cable assembly 10 for transferring tensional loads between a first mechanical system 12 and a second mechanical system 14, via operation of a core element 16 positioned and slidably received within an interior of a conduit 18. It is recognized that the first mechanical system 12 and the second mechanical system 14 can be mechanical components within the same body or mechanism (e.g. within a latch housing) mounted on a location within an automobile 8 (see FIG. 7). Alternatively, the first mechanical system 12 and the second mechanical system 14 can be mechanical components of different systems (e.g. a latch motor and latch contained in separate housings) mounted separately on different locations within the automobile 8.

The first mechanical system 12 has a mechanical component 13 coupled to a first end 20 of the core element 16 and the second mechanical system 14 has a mechanical component 15 coupled to a second end 22 of the core element 16. The mechanical systems 12,14 can be mounted on one or more frames 11 of the automobile as a supporting structure for positioning the mechanical systems 12,14 in a spaced apart distance and/or an specified orientation with respect to one another. The frame(s) 11 can also provide for inhibiting undesirable movement and/or changes in orientation of the mechanical systems 12,14 when the mechanical systems 12,14 are under the influence of the tensional loads. As mentioned above, the mechanical systems 12,14 can be contained within the same or separate housings mounted on the frame(s) 11. As further described below, the core element 16 can be provided as one or more polymer-based strand elements connected at either end 20,22 to polymer-based end fittings 21,23, such that the end fittings 21,23 can be reaction bonded (e.g. physical, chemical) sufficiently to the core element 16 to inhibit end fitting detachment from the core element 16 when under the tensional loads. As such, the end fittings 21,23 are formed on the ends of the core element 16, such that the end fittings 21,23 are configured to inhibit separation from the ends 20,22 of the core element 16 when placed under tensional loads during operation of the mechanical systems 12,14.

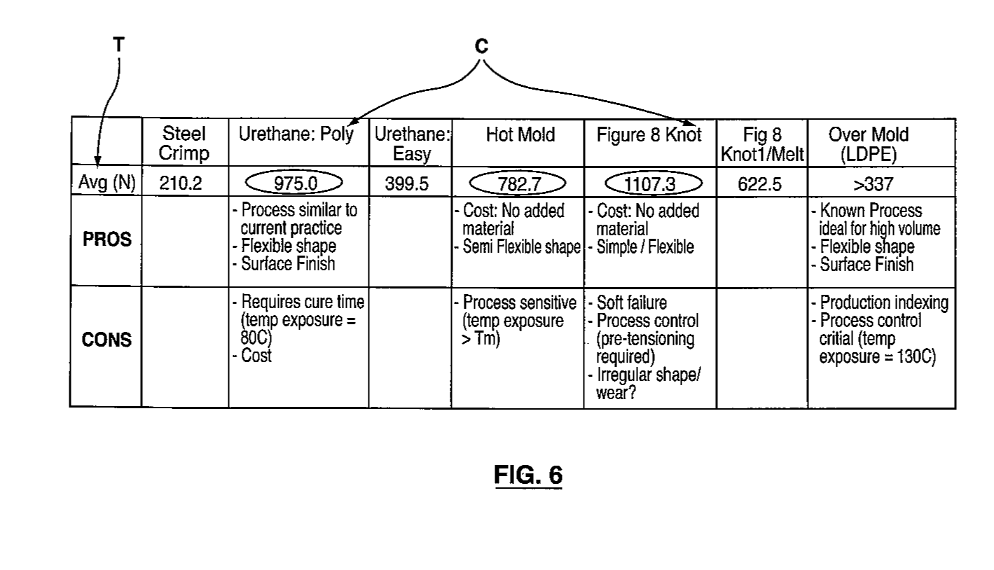

Referring to FIG. 6, shown are testing results for the cable assembly 10 for tensional loads T measured in Newtons N for different configurations C of the end fittings 21,23. As an example configuration of the cable system 10, in an effort to address mass, routing possibilities, and handling, the core element 16 and core end fittings 21,23 of the cable assembly 10 can be provided as a Ultra High Molecular Weight Polyethylene (UHMWPE) cable with reaction bonded (e.g. hot molded) polymer-based end fittings 21,23. Alternatively, as an example configuration of the cable system 10, in an effort to address mass, routing possibilities, and handling, the core element 16 and core end fittings 21,23 of the cable assembly 10 can be provided as a Ultra High Molecular Weight Polyethylene (UHMWPE) cable with reaction bonded (e.g. overmoulded as LOPE) polymer-based end fittings 21,23. Alternatively, as an example configuration of the cable system 10, in an effort to address mass, routing possibilities, and handling, the core element 16 and core end fittings 21,23 of the cable assembly 10 can be provided as a Ultra High Molecular Weight Polyethylene (UHMWPE) cable with molded (e.g. urethane poly) polymer-based end fittings 21,23. Alternatively, as an example configuration of the cable system 10, in an effort to address mass, routing possibilities, and handling, the core element 16 and core end fittings 21,23 of the cable assembly 10 can be provided as a Ultra High Molecular Weight Polyethylene (UHMWPE) cable with mechanically formed (e.g. knotted) polymer-based end fittings 21,23. Alternatively, as an example configuration of the cable system 10, in an effort to address mass, routing possibilities, and handling, the core element 16 and core end fittings 21,23 of the cable assembly 10 can be provided as a Ultra High Molecular Weight Polyethylene (UHMWPE) cable with formed and molded (e.g. knotted amd melted) polymer-based end fittings 21,23.

In terms of application for the cable assembly 10, one example implementation is where the mechanical system 12 is a door latch of a vehicle 8 (e.g. symbolized by the frame 11), which is coupled via the cable assembly 10 as a release cable assembly to the mechanical system 14 provided as a door handle/remote. In this example, the cable assembly 10 is configured for an automotive latching system for a release cable application as a tension cable (commonly referred to as a Bowden cable), such that the cable assembly 10 provides an operative mechanical linkage between the latch (mechanical system 12) and door handle (e.g. mechanical system 14) positioned at a location remote to the latch on the frame 11 (e.g. vehicle body, door frame, etc.). Accordingly, when a vehicle door is unlocked and the door handle/remote is pulled (e.g. mechanical system 14), the release cable (e.g. core element 16) is pulled by a handle lever (e.g. mechanical component 15) and transmits the door handle/remote actuation to a release lever (e.g. mechanical component 13) in the latch, which in-turn opens the door latch and provides for opening of the vehicle door. It is recognised that the conduit 18 can be included or otherwise substituted by one or more carriers as is known in the art, in order to route the core element 16 between the spaced-apart mechanical systems 12,14. In other words, the core element 16 would be routed between the mechanical systems 12,14 without the use of a conduit (e.g. unsheathed) and as such rely on shaped carriers mounted on the frame(s) 11 to route the unsheathed core element 16 in the space between the mechanical systems 12,14. Examples of the automotive latching system, door latch, door handle/remote, release cable assembly, and/or carriers can be found in U.S. Pat. No. 6,247,732 filed on Aug. 9, 1999, herein incorporated by reference.

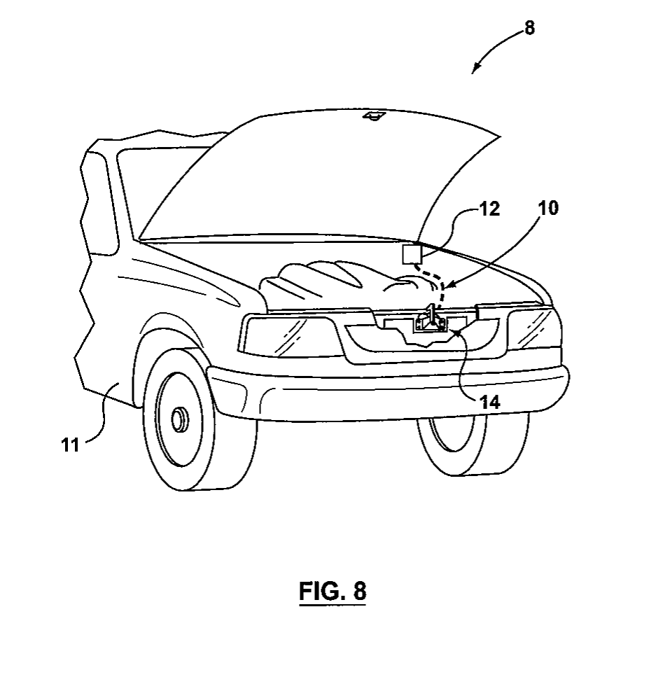

It is recognized that the cable assembly 10 can be applied to different mechanical systems 12,14, such as closure panel latching systems on vehicles. One example of a closure panel latching system on a vehicle 8 is shown in FIG. 7, as a latch (mechanical system 14) with latch lever (mechanical component 13) and a handle (mechanical system 12) with handle lever (mechanical component 15) for a door coupled together by the cable system 10. A further example of a closure panel latching system on a vehicle 8 is shown in FIG. 8, as a latch (mechanical system 14) with latch lever (mechanical component 13) and a handle (mechanical system 12) with handle lever (mechanical component 15) for a hood coupled together by the cable system 10. Further examples for the cable system 10 (see FIG. 1) can include any other vehicle latching applications such as but not limited to decklid (trunk) having a latch (mechanical system 14) with latch lever (mechanical component 13) for the trunklid and a handle (mechanical system 12) with handle lever (mechanical component 15) for releasing the trunklid, fuel filler door and/or cap having a latch (mechanical system 14) with latch lever (mechanical component 13) for the fuel filter door of cap and a handle (mechanical system 12) with handle lever (mechanical component 15) for releasing the fuel filter door or cap, liftgate having a latch (mechanical system 14) with latch lever (mechanical component 13) for the liftgate and a handle (mechanical system 12) with handle lever (mechanical component 15) for releasing the liftgate, etc.

Another example implementation of the cable assembly 10, as a window regulator assembly, is where the mechanical system 12 is a window regulator lifter assembly of a vehicle door (e.g. symbolized by the frame 11) that is coupled via the cable assembly 10 as a window regulator cable assembly to the mechanical system 14 provided as a window motor. In this example, the cable assembly 10 is configured for an automotive window regulator system for a regulator cable application as a tension cable, such that the cable assembly 10 provides an operative mechanical linkage between the window regulator lifter assembly (e.g. mechanical system 12) and the window motor (e.g. mechanical system 14) positioned at a location remote to the window regulator lifter assembly on the frame 11 (e.g. vehicle door frame). Accordingly, when a vehicle window switch activates the window motor (e.g. mechanical system 14), the release cable (e.g. core element 16) is pulled by a motor lever (e.g. mechanical component 15) and transmits the motor actuation to a lifter plate (e.g. mechanical component 13) in the window regulator lifter assembly, which in-turn either opens or closes the window of the vehicle door. It is recognised that the conduit 18 can be included or otherwise substituted by one or more carriers as is known in the art, in order to route the core element 16 between the spaced-apart mechanical systems 12,14. Examples of the window regulator lifter assembly, window motor, window regulator cable assembly, and/or carriers can be found in PCT application number PCT/CA2008/000892 filed on May 9, 2007, herein incorporated by reference.

A further example implementation of the cable assembly 10 is for a seat assembly involving one or more latch mechanisms operated in conjunction with one or more core elements 16 coupled to the mechanical systems 12,14 via core end fittings 21,23. Examples of seat assembly with cable assembly 10 can be found in United States Patent Application 20120161479 filed on Sep. 9, 2010, herein incorporated by reference.

Referring again to FIGS. 1 and 2, shown is the cable assembly 10 having the core element 16 positioned within the conduit 18, such that the core element 16 is slidably received within the interior of the conduit 18. The core element 16 has the first end 20 and the second end 22, such that the first end 20 has the core end fitting 21 connected thereto and the second end 22 also has the core end fitting 23 connected thereto. The conduit 18, optional, has a conduit bushing 24 for coupling or otherwise anchoring the conduit 18 of the cable assembly 10 to the first mechanical system 12 and a conduit bushing 26 for coupling or otherwise anchoring the conduit 18 of the cable assembly 10 to the second mechanical system 14. The conduit bushings 24,26 provide fixed attachment points of the conduit 18 to each of the respective mechanical systems 12,14, such that compressive loading is transferred to the conduit 18 when the core element 18 is under the tensioning load during operation of the mechanical components 13,15 as mechanically coupled by the cable assembly 10. It is recognised that the polymer-based core 18 and polymer-based core end fittings 21,23 can be referred to as a core sub-assembly of the cable assembly 10, for example for use as a core sub-assembly without the conduit 18 (e.g. unsheathed) to facilitate compliance with specified application in automotive door release cables.

As discussed, the core element 16 can be provided as one or more polymer-based strand elements connected at either end 20,22 to the polymer-based end fittings 21,23, such that the end fittings 21,23 can be (e.g. reaction) bonded sufficiently to the core element 16 to inhibit end fitting detachment from the core element 16 when under the tensional loads. One advantage of a polymer-based cable (i.e. polymer core element 16 bonded to polymer core end fittings 21,23) is that it helps to reduce the cable mass significantly, as compared to the mass of current cables provided as braided steel wire mechanically terminated (i.e. non-bonded) by crimped metal or composite ferrules. As such, the polymer cable assembly 10 describe can be compatible with the incentives throughout the automotive industry to reduce cable system mass.

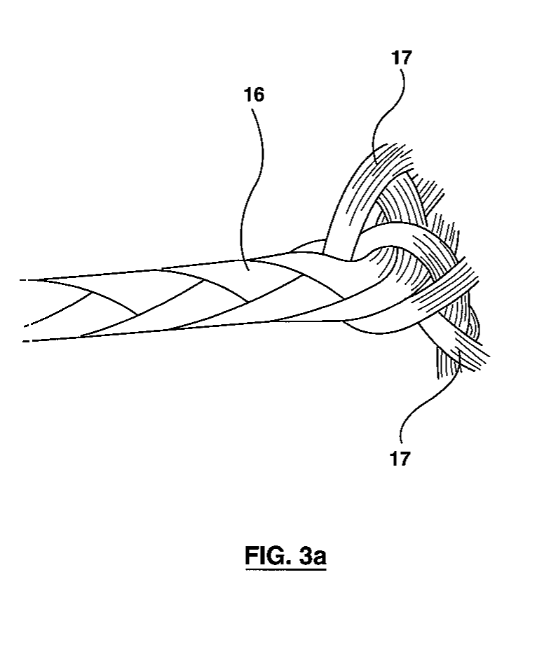

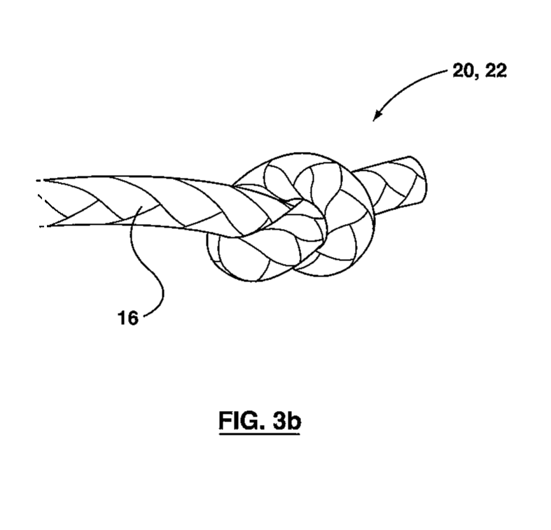

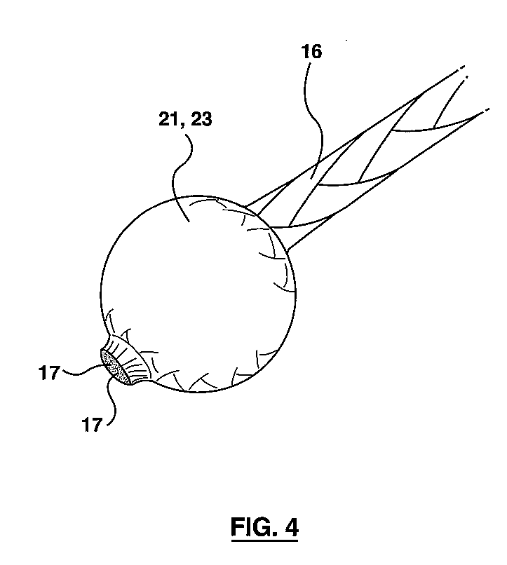

The core element 16 can be provided as a multi-strand cable, such that one or more or the polymer strands 17 (see FIG. 3) of the core element 16 can be bonded by a chemical reaction (e.g. attached by adhesive) bond and/or by a physical reaction bond of melting (e.g. physical process involving a phase transition) to the polymer-based end fittings 21,23 (see FIG. 4). In other words, “chemical reaction bond” vs “physical reaction bond” can be defined as covalent bonding vs. hydrogen and/or van der waal bonding, for example.

Specific example processes of reaction bonding between the polymer material of the core element 16 and the polymer material of the core end fittings 21,23 are provided further below. It is also recognised that one or more of the strands of the multi-strand core element 16 can be strands other than polymer-based, e.g. non-polymer based material such as metal strand, composite material strand, etc. Example polymer/synthetic material of the polymer/synthetic strands of the core element 16 can be such as Ultra High Molecular Weight Polyethylene (UHMWPE). Example polymer material of the core end fittings 21,23 is polymer material such as but not limited to polyurethane, polyethylene, Ultra High Molecular Weight Polyethylene, 2K Polyurethane (PolyTek, Poly-Optic 1412), PE with low Tm and high MFI, low density polyethylene with low Tm and high MFI, low density polyethylene, special low density polyethylene, nylon, high density polyethylene, glass filled polyethylene, polypropylene. As such, the synthetic fibres/strands 17 for the core element 16 can include polypropylene, nylon, polyesters (e.g. PET, LCP, HDPE, Vectran), polyethylene (e.g. Dyneema and Spectra), Aramids (e.g. Twaron, Technora and Kevlar) and acrylics (e.g. Dralon), for example.

Some core elements 16 can be constructed of mixtures of several fibres/strands 17 or use co-polymer fibres/strands 17. Selected fibres/strands 17 of the multi fibre/strand core element 16 can also be made out of metal or other non-polymers (or other synthetic material), as desired.

It is recognised that melt temperature of the core end fittings 21,23 polymer material can be higher than the melt temperature of the strand 17 polymer material, in order to facilitate reaction bonding between the strands 17 and the core end fittings 21,23 without negatively affecting the material structural integrity of the core element 16 (i.e. multi-stranded) in the vicinity of the core end fittings 21,23.

In any event, it is recognised that bond temperature of the core end fittings 21,23 polymer material can be lower than the melt temperature of the strand 17 polymer material, in order to facilitate reaction bonding between the strands 17 and the core end fittings 21,23 without negatively affecting the material structural integrity of the core element 16 (i.e. multi-stranded) in the vicinity of the core end fittings 21,23.

The core element 16 can be defined as a linear collection (e.g. multi fibre/strand) of plies, yarns or strands 17 which are twisted or braided together in order to combine them into a multi-stranded/fibred cable. The core element 16 is configured to have tensile strength and so can be used for transference of tensional loads (e.g. dragging and lifting), but the core element 16 is considered too flexible to provide compressive strength during operation of the cable assembly 10 with respect to the mechanical systems 12,14. As a result, the core element 16 of the cable assembly 10 may not be used for pushing or similar compressive applications. The core element 16 can be referred to as a cable, cord, line, string, and/or twine as desired. It is understood that the twist of the strands 17 in a twisted or braided core element 16 serves not only to keep a core element 16 together, but provides for the core element 16 to more evenly distribute tension among the individual strands 17. Without any twist in the core element 16, the shortest strand(s) 17 could always be supporting a much higher proportion of the total load of the core element 16. Styles of core element 16 construction can include element types such as but not limited to: laid or twisted cable; braided cable (single braid, double braid, solid braid); plaited cable; brait cable; and endless winding cable, as desired.

As discussed, by using a polymer-based multi-stranded cable for the core element 16 and polymer-based core end fittings 21,23 reaction bonded to the core element 16, advantages of a reduction in mass of the cable assembly, increased corrosion resistance, reduced rigidity, and/or allowance for smaller bend radii and more flexibility in routing while inhibiting the risk of mechanical damage can be provided as compared to more traditional steel cables while still meeting automotive application strength requirements.

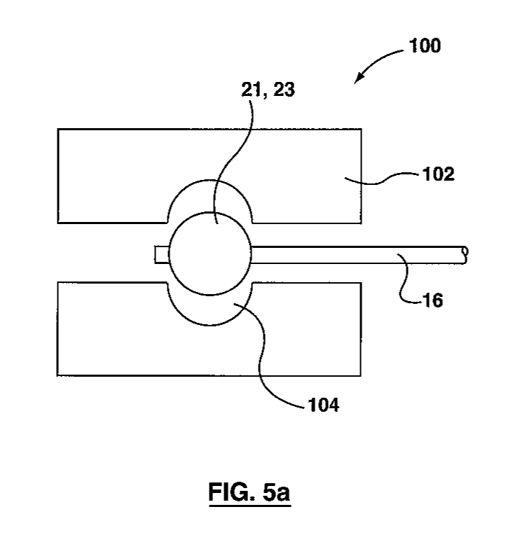

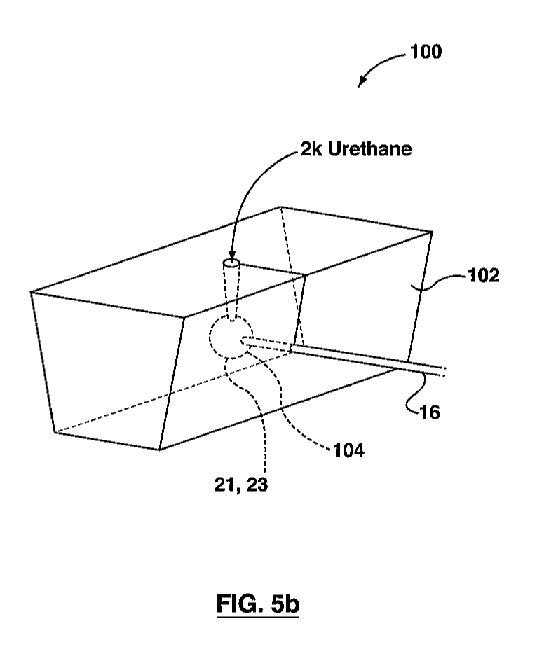

Referring to FIG. 5a,b, an example manufacture environment and process(es) 100 of the core element 16 is shown for implementing reaction bonding of the core end fittings 21,23 to the core element 18. Example parameters of the manufacturing environment and process(es) can be: 1. the cable core 16 and end fittings 21,23 can be entirely polymer material; 2. the cable core 16 and end fittings 21,23 can be bonded together sufficiently to withstand end fitting retention requirements (e.g. 900N tension load)—the cable core element 16 cannot break and the core end fittings 21,23 cannot separate from the core element 16 and/or break under subjected tension loadings; 3. the melting temperature of the example material UHMWPE material can be 147 C, making it sensitive to temperature manufacturing techniques for end fitting 21,23 reaction bonding assembly to the core element 16, as the melting temperature of the end fitting 21,23 polymer material is higher than the melt temperature of the core element 16 to provide for flow of the core end fitting 21,23 material about the end 20,22 of the core element 16 to melt a portion of the core element 16 material to provide for the chemical reaction bond between the core element 16 and end fitting 21,23 materials; 4. the cable sub-assembly can be durable through cyclic life requirements of the tension loading and exposure to extreme environmental conditions (e.g. +80° C., +130° C., −40° C., 38° C. 95% RH); and/or 5. the core 16 and core end fitting 21,23 strand 17 material can be compatible with the environment (e.g. conduit 18 liner material, lubrication, etc.) and can be robust to substantive performance degradation over time.

Several example techniques and materials were developed to attach the polymer-based end fitting 21,23 to the polymer-based core element 16 (e.g. UHMWPE braided cable) that can provide for end fitting retention, durability and/or compatibility requirements for automotive applications such as but not limited to automotive latching systems and automotive window regulator systems. For reaction bonded attachment techniques, a mold 102 is provided having a mold cavity 104 for inserting the end fitting 21,23 and core element 16 therein (see FIGS. 5a,5b).

Referring to FIG. 5b, a first manufacturing process 100 embodiment is uses the polymer material of the end fittings 21,23 as 2K polyurethane (PolyTek, Poly-Optic 1412). The end 20,22 of the core element 16 is positioned in cavity 104 of the mould 102. Next, the end fitting 21,23 material is deposited into the cavity 102 as a liquid Cast using two part dispensing as isocyanate and resin followed by heat cure, such that the cure temperature of the end fitting 21,23 polymer material is different (e.g. lower or higher) than the melt temperature of the core element 16 (e.g. in the case of 2K polyurethane the cure temp is 80 C and thus lower than the melt temperature of the polymer material for the core element 16, as compared to an injection moulding process 100 where the injection temperature of the polymer material of the core end fittings 21,23 would be higher than the melt temperature of the core element 16) to provide for flow of the core end fitting 21,23 material about the end 20,22 of the core element 16 to bond with a portion of the core element 16 material to provide for the reaction bond between the core element 16 and end fitting 21,23 materials. Accordingly, the cast of the end fitting 21,23 to form the end fillings 21,23 is performed as over “upset” at one end of the core element 16 (e.g. UHMWPE braided cable), such that the individual strands 17 are oriented as flared apart (see FIG. 3a) to increase the surface area of the strands 17 at the core element end 20,22 to facilitate adhesion of the core end fitting 21,23 material. Once cured, the core element end 20,22 is removed from the cavity 104 to result in the formed end fitting 21,23 on the core element end 20,22, as shown in FIG. 4. It is recognised that the length of the core element fitting 21,23 along the length of the core element 16 can be between 2 to 6 mm, or more, depending upon the application. Further, the end fittings 21,23 can be formed as irregular shapes (e.g. L-bends, S-bends), which can be higher bond lengths, for example as a minimum length (e.g. 2 mm). It is also recognised that rather than the use of a flared configuration for the end 20,22 of the core element 16, one or more knots (see FIG. 3b) can be used for encapsulation inside of the polymer material forming the end fitting 21,23 during the manufacturing process 100. Alternatively, the knots can be used themselves as the end fittings 21,23.

Referring to FIG. 5a, a second manufacturing process 100 embodiment is uses the polymer material of the end fittings 21,23 as low density polyethylene (LDPE) as Over-Molding for the core element 16. The end 20,22 of the core element 16 is positioned in cavity 104 of the mould 102. Next, the end fitting 21,23 material is deposited into the cavity 104 as liquid overmold material, such that the temperature of the end fitting 21,23 polymer material is different (e.g. higher or lower) than the melt temperature of the core element 16 (e.g. HDPE and PA6 (Nylon) have melt temps>UHMWPE for moulding while LDPE is lower melt temperature) to provide for flow of the core end fitting 21,23 material about the end 20,22 of the core element 16 to bond with a portion of the core element 16 material to provide for the reaction bond between the core element 16 and end fitting 21,23 materials. Over-molding of LDPE with low Tm and high MFI can be done to preserve core element 16 structural integrity using conventional injection molding equipment. For example, the cavity 104 insert can be designed to promote core fitting 21,23 material flow in favourable directions during processing to facilitate maintaining attachment of the end fittings 21,23 at the core element ends 20,22 for cable tensioning. Accordingly, the overmould of the end fitting 21,23 to the core element ends 21,23 form the end fittings 21,23 is performed” at the core element ends 20,22 of the core element 16 (e.g. UHMWPE braided cable), such that the individual strands 17 can be oriented as knotted (see FIG. 3b) to increase the surface area of the strands 17 at the core element end 20,22 to facilitate adhesion of the core end fitting 21,23 material due to the reaction bond between the core element ends 20,22 material and the core end fittings 21,23 material. Once hardened, the core element end 20,22 is removed from the cavity 104 to result in the formed end fitting 21,23 on the core element end 20,22, as shown in FIG. 4. It is recognised that the length of the core element fitting 21,23 along the length of the core element 16 can be between 2 to 6 mm, or alternatively at least 2 mm. As discussed above, a flared end 20,22 may not be feasible for over-moulding due to tensioning requirement and therefore the knot end 20,22 configuration (see FIG. 3b) is preferred. Flared configuration (see FIG. 3a) for the end 20,22 can provide for urethane/epoxies applied using a room temperature moulding parameter.

Referring to FIG. 5a, a third manufacturing process 100 embodiment is uses the polymer material of the end fittings 21,23 as hot compression molding using knotted core element 16 (e.g. UHMWPE braided cable). This is performed by tying one or more common overhand knots in the core element 16 at either core element end 20,22, on top of one another, such that the final knot formation (one or more knots) can be larger (e.g. 5-10%) over the intended end fitting 21,23 geometry. The end 20,22 of the core element 16 is positioned in cavity 104 of the mould 102. Next, with the end fitting 21,23 material as the knot formation of the core element 16 material itself is deposited into the cavity 104, the temperature of the combined core element 16 and end fitting 21,23 polymer material is raised to higher than the melt temperature of the core element 16 to provide for reforming of the core end fitting 21,23 material about the end 20,22 of the core element 16 to melt a portion of the core element 16 material to provide for the chemical reaction bond between the core element 16 and end fitting 21,23 materials. Heating of the metallic mold 100 is performed, such that the cavity 104 is shaped to the desired geometry (6 mm sphere in this case) to a temperature slightly higher (e.g. between 3-5 degree C.) than the Tm of the core element 16 material (e.g. for the UHMWPE, approximately 150° C.). Further, the knot formation can be placed in the mold cavity 104 and immediately compressed under pressure for 2 to 4 minutes thereby creating an outer molten shell of PE material, which when cooled forms the core end fitting 21,23. Once hardened, the core element end 20,22 is removed from the cavity 104 to result in the formed end fitting 21,23 on the core element end 20,22, as shown in FIG. 4. It is recognised that the length of the core element fitting 21,23 along the length of the core element 16 can be between 2 to 6 mm, or alternatively at least 2 mm for example.

It is also recognised that the core end fittings 21,23 can be provided as an unmelted knot formation, i.e. not subjected to melting. This manufacture of the core end fittings 21,23 at either end 20,22 of the core element 16 can be performed by tying a one or two figure eight knots (or other knot configurations) and allowing them alone to act as the end fitting 21,23.

In terms of a number of further embodiments. An automotive assembly comprising: a first mechanical system having a first mechanical component, the first mechanical system configured for mounting on a first body portion of a vehicle; a second mechanical system having a second mechanical component, the second mechanical system configured for mounting on a second body portion of the vehicle, the second body portion spaced apart from the first body portion; and a cable assembly for mechanically linking the first mechanical system to the second mechanical system for facilitating a transfer of tension loadings there-between, the cable assembly having a multi-stranded polymer-based core element having a first polymer based end fitting at a first end and a second polymer based end fitting at a second end such that the first polymer based end fitting is for retaining a coupling to the first mechanical component of the first end and the second polymer based end fitting is for retaining coupling to the second mechanical component at the second end during the transfer of tension loading.

It is recognised that the first mechanical system can be the door latch, the first mechanical component the latch lever, the second mechanical system the door handle/remote and the second mechanical component is the door lever. It is recognised that the first mechanical system is the window motor, the first mechanical component is the motor lever, the second mechanical system is the window regulator lifter assembly and the second mechanical component is the window lifter plate. It is recognised that the cable assembly includes a conduit for housing the polymer based core element in a interior of the conduit, the conduit having a first conduit end with a first bushing for connecting to the first mechanical system and a second conduit end with a second bushing for connecting to the second mechanical system. It is recognised that the multi-stranded polymer-based core element is bonded at each of the core ends by a reaction bond to the respective polymer based end fitting. It is recognised that the respective polymer based end fitting is of a polymer material different than a polymer material of the multi-stranded polymer-based core element. It is recognised that the respective polymer based end fitting is of a polymer material the same as the polymer material of the multi-stranded polymer-based core element. It is recognized that that the core element 16 can contain one or more strands 17 which are non-polymer based (e.g. metal, composite material, etc.)

A further embodiment is a method of manufacturing a polymer based end fitting on a multi-stranded polymer-based core element, the method comprising the steps of: positioning an end of the multi-stranded polymer-based core element in a cavity of a mold; applying end polymer material of the polymer based end fitting (e.g. in the cavity) at a temperature (or pressure causing) exceeding a melt temperature of core polymer material of the multi-stranded polymer-based core element, such that a chemical reaction bond is formed between the end polymer material and the core polymer material; allowing the end polymer material to harden to form the polymer based end fitting on the end; and removal of the multi-stranded polymer-based core element with the polymer based end fitting (e.g. from the mold). It is recognised that the end polymer material can be composed of a different material (or same material) to that of the core polymer material.

A further embodiment is a method of manufacturing a polymer based end fitting on a multi-stranded polymer-based core element, the method comprising the steps of: positioning an end of the multi-stranded polymer-based core element (e.g. in a cavity of a mold) including end polymer material of the polymer based end fitting, such that the end polymer material and the core polymer material are integrally connected; processing the end polymer material of the polymer based end fitting (e.g. in the cavity) at a temperature exceeding a melt temperature of core polymer material of the multi-stranded polymer-based core element, such that a reaction bond is formed between the end polymer material and the core polymer material on the end; allowing the end polymer material to harden to form the polymer based end fitting; and removal of the multi-stranded polymer-based core element with the polymer based end fitting (e.g. from the mold). It is recognised that the end polymer material can be formed from one or more knots in the core polymer material. It is recognized that a processing condition (e.g. elevated pressure causing melting of the material to occur, elevated temperature causing melting of the material to occur) can be used to form the reaction bond between the core element 16 and the end fittings 21,23. The processing condition can be caused by application of pressure/temperature conditions in a mold. Alternatively, or in addition to, the processing condition can be caused by application of pressure/temperature conditions via application of a laser to the material(s).

A further embodiment is a cable assembly for mechanically linking the first mechanical system to the second mechanical system for facilitating a transfer of tension loadings there-between, the cable assembly having a multi-stranded polymer-based core element having a first polymer based end fitting at a first end and a second polymer based end fitting at a second end such that the first polymer based end fitting is for retaining a coupling to the first mechanical component of the first end and the second polymer based end fitting is for retaining coupling to the second mechanical component at the second end during the transfer of tension loading.

It is recognized that the first mechanical system is a door latch, the first mechanical component is a latch lever, the second mechanical system is a door handle/remote and the second mechanical component is a door lever. It is recognised that the first mechanical system is a window motor, the first mechanical component is a motor lever, the second mechanical system is a window regulator lifter assembly and the second mechanical component is a window lifter plate. It is recognised that the cable assembly includes a conduit for housing the polymer based core element in a interior of the conduit, the conduit having a first conduit end with a first bushing for connecting to the first mechanical system and a second conduit end with a second bushing for connecting to the second mechanical system. It is recognised that the multi-stranded polymer-based core element is bonded at each of the core ends by a reaction bond to the respective polymer based end fitting.

We claim:

1. An automotive assembly comprising:
a first mechanical system having a first mechanical component, the first mechanical system configured for mounting on a vehicle;
a second mechanical system having a second mechanical component, the second mechanical system configured for mounting on the vehicle, the second mechanical component spaced apart from the first mechanical component; and
a cable assembly for mechanically linking the first mechanical system to the second mechanical system for facilitating a transfer of tension loadings there-between, the cable assembly having a multi-stranded polymer-based core element having a first polymer based end fitting at a first end and a second polymer based end fitting at a second end such that the first polymer based end fitting is for retaining coupling to the first mechanical component of the first end and the second polymer based end fitting is for retaining coupling to the second mechanical component at the second end during the transfer of tension loading.

2. The automotive assembly of claim 1, wherein the first mechanical system is a door latch, the first mechanical component is a latch lever, the second mechanical system is a door handle/remote and the second mechanical component is a door lever.

3. The automotive assembly of claim 1, wherein the first mechanical system is a window motor, the first mechanical component is a motor lever, the second mechanical system is a window regulator lifter assembly and the second mechanical component is a window lifter plate.

4. The automotive assembly of claim 1, wherein the cable assembly includes a conduit for housing the polymer based core element in an interior of the conduit, the conduit having a first conduit end with a first bushing for connecting to the first mechanical system and a second conduit end with a second bushing for connecting to the second mechanical system.

4. The automotive assembly of claim 1, wherein the multi-stranded polymer-based core element is bonded at each of the core ends by a reaction bond to the respective polymer based end fitting.

5. The automotive assembly of claim 4, wherein a melt temperature of the polymer based end fitting is greater than a melt temperature of the multi-stranded polymer-based core element.

6. The automotive assembly of claim 4, wherein a melt temperature of the polymer based end fitting is less than a melt temperature of the multi-stranded polymer-based core element.

7. The automotive assembly of claim 1, wherein the respective polymer based end fitting is of a polymer material different than a polymer material of the multi-stranded polymer-based core element.

8. The automotive assembly of claim 1, wherein the respective polymer based end fitting is of a polymer material the same as the polymer material of the multi-stranded polymer-based core element.

9. The automotive assembly of claim 1 further comprising a non-polymer based strand material providing one or more strands of the multi-stranded polymer-based core element.

10. An automotive cable assembly for mechanically linking a first mechanical system to a second mechanical system for facilitating a transfer of tension loadings therebetween, the cable assembly having a multi-stranded polymer-based core element having a first polymer based end fitting at a first end and a second polymer based end fitting at a second end such that the first polymer based end fitting is for retaining coupling to the first mechanical component of the first end and the second polymer based end fitting is for retaining coupling to the second mechanical component at the second end during the transfer of tension loading.

11. A method of manufacturing a polymer based end fitting on a multi-stranded polymer-based core element, the method comprising the steps of:
positioning an end of the multi-stranded polymer-based core element in a cavity of a mold;
applying end polymer material of the polymer based end fitting in the cavity at a prescribed temperature different from a melt temperature of core polymer material of the multi-stranded polymer-based core element, such that a chemical reaction bond is formed between the end polymer material and the core polymer material;
allowing the end polymer material to harden to form the polymer based end fitting on the end; and
removal of the multi-stranded polymer-based core element with the polymer based end fitting from the mold.

12. The method of claim 11, wherein the end polymer material is composed of a material different to that of the core polymer material.

13. The method of claim 11, wherein the end polymer material is composed of a material the same as that of the core polymer material.

14. A method of manufacturing a polymer based end fitting on a multi-stranded polymer-based core element, the method comprising the steps of:
positioning an end of the multi-stranded polymer-based core element in end polymer material of the polymer based end fitting;
applying a process condition to cause the end polymer material to form around core polymer material of the multi-stranded polymer-based core element, such that a chemical reaction bond is formed between the end polymer material and the core polymer material; and
allowing the end polymer material to harden to form the polymer based end fitting on the end.

15. The method of claim 14, wherein the process condition is selected from the group consisting of: a prescribed temperature causing the end polymer material to melt; and a prescribed pressure causing the end polymer material to melt.

16. The method of claim 14, wherein the end polymer material is composed of a material different to that of the core polymer material.

17. The method of claim 14, wherein the end polymer material is composed of a material the same as that of the core polymer material.

18. A method of manufacturing a polymer based end fitting on a multi-stranded polymer-based core element, the method comprising the steps of:
positioning an end of the multi-stranded polymer-based core element including end polymer material of the polymer based end fitting, such that the end polymer material and the core polymer material are integrally connected;
processing the end polymer material of the polymer based end fitting to form a reaction bond between the end polymer material and the core polymer material on the end; and
allowing the end polymer material to harden to form the polymer based end fitting.

19. The method of claim 18, wherein the end polymer material is formed from one or more knots in the core polymer material.
